(19) United States
(12) Patent Application Publication
(10) Pub. No.: US 2010/0228528 A1
(43) Pub. Date: Sep. 9, 2010

(54) SITING PLAN SYSTEMS AND METHODS

(76) Inventor: Robert Nicolucci, Richmond Hill (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/559,297

(22) Filed: Sep. 14, 2009

Related U.S. Application Data
(60) Provisional application No. 61/096,873, filed on Sep. 15, 2008.

(51) Int. Cl. G06F 17/50

(52) U.S. Cl. 703/1

(57) ABSTRACT

Systems and methods for siting at least one model on a siting plan. The system may include: a site plan database and a siting generator operatively coupled to the site plan database. The site plan database may include at least one layout record corresponding to a site plan having a set of at least one lot. The siting generator is configured to generate a siting plan corresponding to the layout record. The siting generator may be configured to determine a plurality of lot boundaries on the siting plan, with each lot boundary corresponding to at least one lot on the siting plan. The siting generator may further be configured to determine a model/lot siting corresponding to a combination of a model and a lot on the siting plan.

### PRIORITY

This application claims priority from U.S. provisional patent application No. 61/096,873, filed Sep. 15, 2008, which is incorporated by reference herein in its entirety.

### TECHNICAL FIELD

Embodiments described herein relate generally to real estate applications with specific, but by no means exclusive application to systems and methods that provide for the siting and display of housing models on lots.

### BACKGROUND

Real estate projects typically permit potential buyers to choose from various available lots within the development project, and also to select one of the models (and elevation of such selected model, if more than one is available) to be built on the chosen lot. Visualization of the siting of combinations of one or more models on one or more lots may be difficult.

Accordingly, in one aspect, the inventor has recognized a need for systems and methods to facilitate the siting of at least one model on at least one lot.

### BRIEF DESCRIPTION OF THE DRAWINGS

For a better understanding of example embodiments described herein, and to show more clearly how they may be carried into effect, reference will now be made, by way of example, to the accompanying drawings in which:

FIG. 1 is a block diagram of a model siting system in one example implementation.

FIG. 2A is a schematic illustration of one embodiment of an example pre-existing site plan corresponding to a proposed development project.

FIG. 2B is a schematic illustration of an example of a first layout record corresponding to the site plan of FIG. 2A.

FIG. 2C is an example siting plan corresponding to the site plan of FIG. 2A as may be generated in accordance with the present disclosure.

FIG. 2D is a schematic illustration of another embodiment of an example pre-existing site plan corresponding to a proposed development project.

FIG. 2E is a schematic illustration of another example of a first layout record corresponding to the site plan of FIG. 2D.

FIG. 2F is another example siting plan corresponding to the site plan of FIG. 2D as may be generated in accordance with the present disclosure.

FIG. 3A is a schematic illustration of example model records containing exemplary data as may be stored in the model database of FIG. 1.

FIG. 3B is a schematic illustration of an example model footprint as may be stored in the model database of FIG. 1.

FIG. 4A is a schematic illustration of example model/lot siting records containing exemplary data as may be generated herein and stored in the model/lot siting database of FIG. 1.

FIG. 4B is an example screen shot of exemplary model/lot siting images of a particular model sited on a particular lot, as may be generated herein and stored in model/lot siting records and selectively presented on the display of FIG. 1.

FIG. 5 is a flowchart illustrating steps of a method of siting at least one model on at least one lot in accordance with at least one embodiment.

FIGS. 6-9 are schematic illustrations of close-up portions of different example siting plans as may be generated and analyzed in accordance with the present disclosure.

### DETAILED DESCRIPTION

Embodiments described herein are generally directed to systems and methods for siting properties. Some embodiments of the system described herein may be implemented as or incorporated into a sales tool or application. During the selling process, using such a tool a sales agent may be able to show prospective home buyers one or more available lots in a project and images of available house models/elevations for such lot(s).

In a broad aspect, there is provided a method for siting at least one model on a siting plan. The method may include: providing a site plan comprising at least one lot and providing a first layout record corresponding to the site plan. By way of example only, the first layout record will often be a first electronic layout record and may comprise an engineering or survey drawing. A first electronic layout record may be stored on a computer readable medium, for example, on a hard drive, memory stick, compact disc or other appropriate storage medium. The method may further include: generating a siting plan corresponding to the first electronic layout record and determining a plurality of lot boundaries on the siting plan, wherein each lot boundary corresponds to at least one lot on the siting plan. The method may also include determining at least one model/lot siting, each model/lot siting corresponding to a model and lot combination.

As will be understood, in some implementations in which the site plan comprises a single lot, the method may be used to site a single model on a single lot.

In certain implementations, the plurality of lot boundaries are determined from the first electronic layout record. A boundary type for each lot boundary may also be determined. The boundary type may be, for example, front, rear, or side.

In some implementations, determining the model/lot siting comprises determining for each of a plurality of models a model/lot siting corresponding to one lot on the siting plan. As well, in some implementations, determining the model/lot siting comprises determining for one model a model/lot siting for each of a plurality of lots on the siting plan.

The method may also include generating a model/lot siting database comprising at least one model/lot siting record, wherein each model/lot siting record comprises a model/lot siting for the model and lot combination.

In some embodiments, the method may further include determining at least one siting restriction for at least one lot on the siting plan. By way of example only, the siting restrictions may include zoning and/or setback requirements. A model record may also be provided for each model, wherein each model record comprises a model plan corresponding to a footprint of the corresponding model.

In some implementations, the method may include for at least one model, determining if the model is able to be sited on at least one lot. Determining if the model may be sited on the at least one lot may involve determining the approximate width of the model. Certain embodiments may involve determining a width value of the at least one lot. In the method, determining if the model is sufficiently sized may involve comparing the approximate width of the model with the width value of the at least one lot.

Some embodiments of the method may involve determining the availability of each model to be sited on each lot. Additionally, some implementations may involve the siting plan having a plurality of lots and determining a proximity relationship between at least two lots, which in some instances may include identifying which lots are adjacent to each other. For example, some lots may be side-by-side, back-to-back, or side-to-back. In other instances, the proximity relationship may correspond to which lots are across a street from each other.

A computer-readable medium comprising instructions executable on a processor of a computing device for implementing the method(s) may also be provided.

Yet another broad aspect is directed towards a model siting system for siting at least one model on a siting plan. The system may include: a site plan database and a siting generator operatively coupled to the site plan database. The site plan database may include at least one layout record corresponding to a site plan having a set of at least one lot. The siting generator is configured to generate a siting plan corresponding to the layout record. The siting generator may be configured to determine a plurality of lot boundaries on the siting plan, with each lot boundary corresponding to at least one lot on the siting plan. The siting generator may further be configured to determine a model/lot siting corresponding to a combination of a model and a lot on the siting plan.

In some embodiments, the siting generator may be configured to determine the plurality of lot boundaries from the layout record. As well, the siting generator may be configured to determine a boundary type for each lot boundary. By way of example, the boundary type may be selected from the group consisting of: front; rear; and side (sometimes referred to herein as flankage). The boundary type may also specifically include right side and left side.

In certain implementation, the system may include a model/lot siting database configured to store at least one model/lot siting record corresponding to the model/lot siting determined by the siting generator.

The siting generator may also be configured to determine siting restrictions for at least one lot.

The system may include a model database configured to store at least one model record, wherein each model record corresponds to a model and includes a model plan corresponding to a footprint of the corresponding model.

For some implementations, the siting generator may be configured to determine if a selected model selected from the at least one model is able to be sited on a selected lot which may be selected from the set.

In implementations in which the set includes a plurality of lots, the siting generator may also be configured to determine the relationship between at least two lots. For example, the siting generator may be configured to determine which lots in the siting plan are adjacent to each other.

These and other aspects and features of various embodiments will be described in greater detail below.

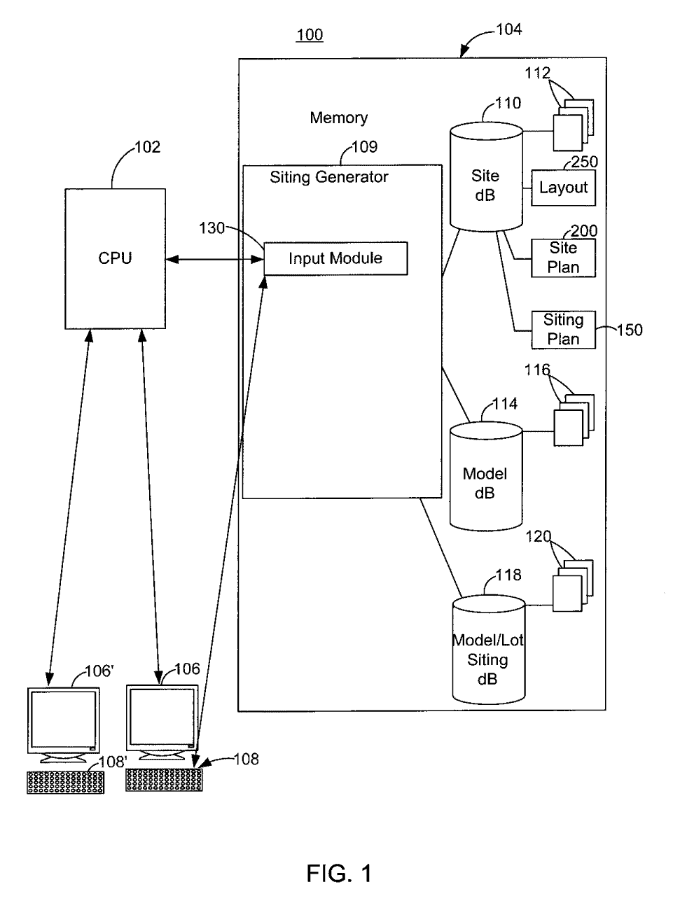

Referring first to FIG. 1, a block diagram of a model siting system in one example implementation is shown generally as 100. System 100 comprises a number of components, including (micro)processor 102 which may form part of a computer system. Microprocessor 102 controls the overall operation of system 100. Processor 102 also interacts with additional subsystems such as memory storage 104 (which may include random access memory (RAM) and read-only memory (ROM), and persistent storage such as flash memory, and may also include combinations of local and remote storage), display 106, and input device(s) 108, for example, such as a keyboard, mouse, touchscreen (which may form part of the display 106) or touchpad.

Microprocessor 102, in addition to its operating system functions, enables execution of software applications which may include a siting generator module or computer program 109, typically stored in storage 104 and programmed to cause the CPU (central processing unit) 102 to provide the functionality discussed herein. The siting generator 109 comprises accurate drawing capabilities, as may be provided by CAD (computer aided design) software.

The system 100 may also include within the storage 104 a site database 110, which may store one or more siting plans 150 as generated and stored herein. The site database 110 may include at least one layout record 250 (such as an engineering drawing and/or a survey drawing), as well a model database 114 having a model record 116 for each of the housing models. Often, the layout record 250 will be an electronic layout record and will be stored on one or more computer readable media. The layout record 250 contains measurements and/or location data, as may be prepared and stored in a CAD drawing, for example. The data and the storage structure set out herein are provided for illustrative purposes only—alternate data and/or storage formats (including both local and remote storage) may be used.

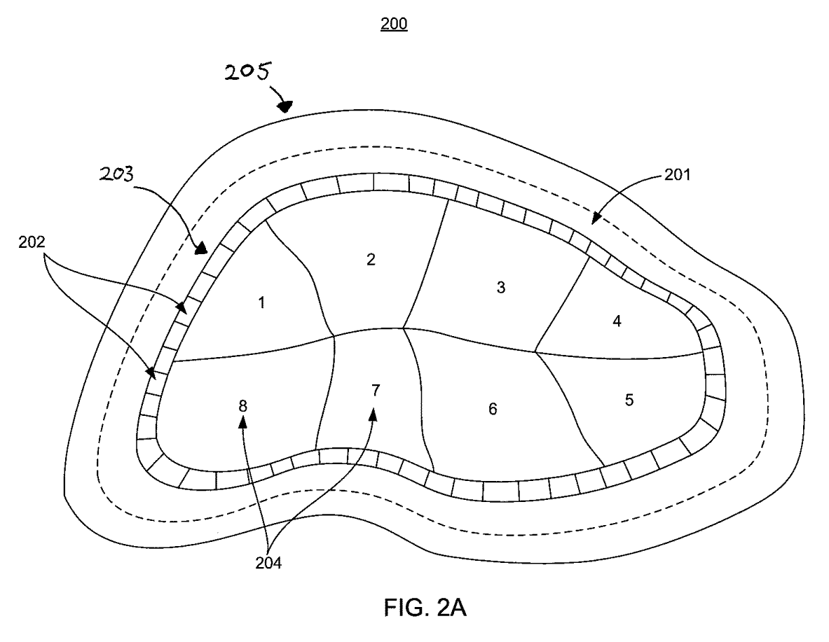

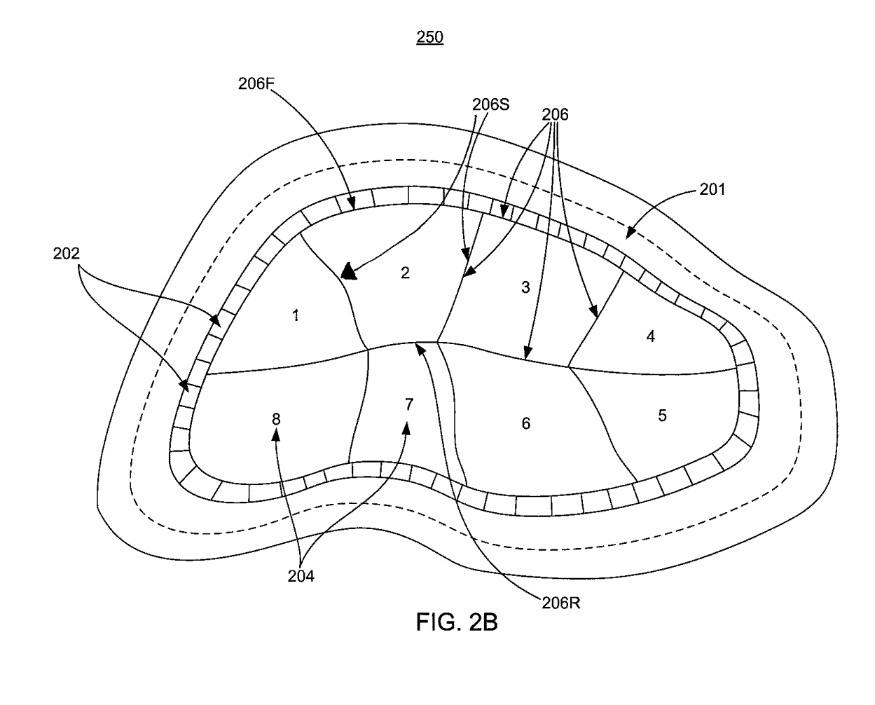

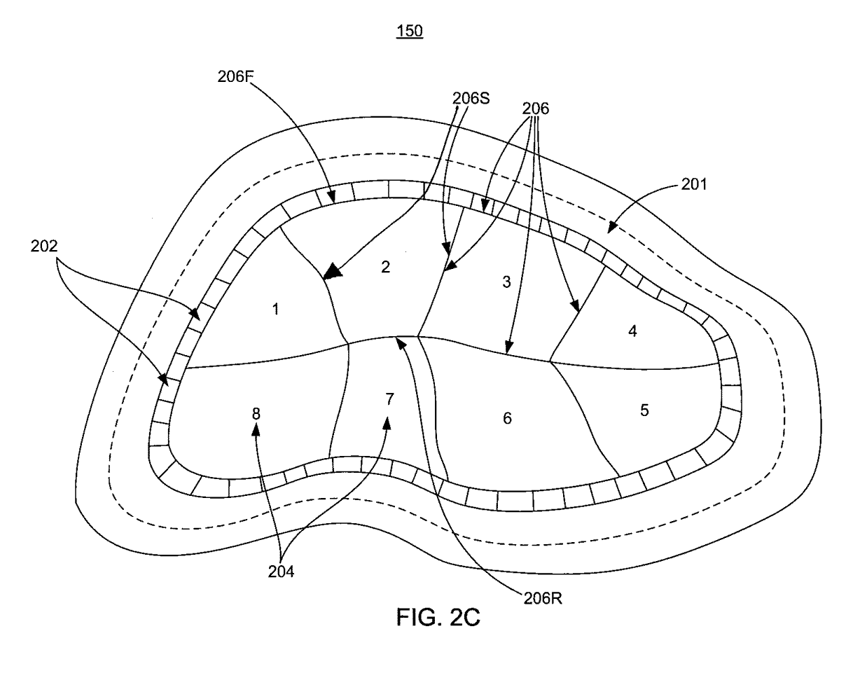

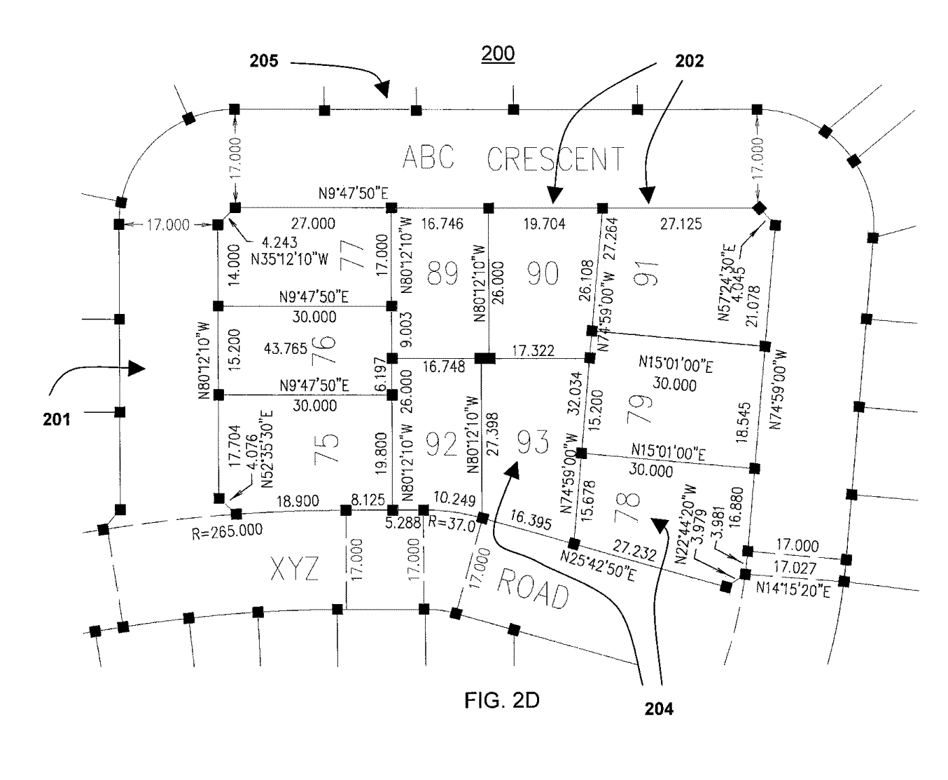

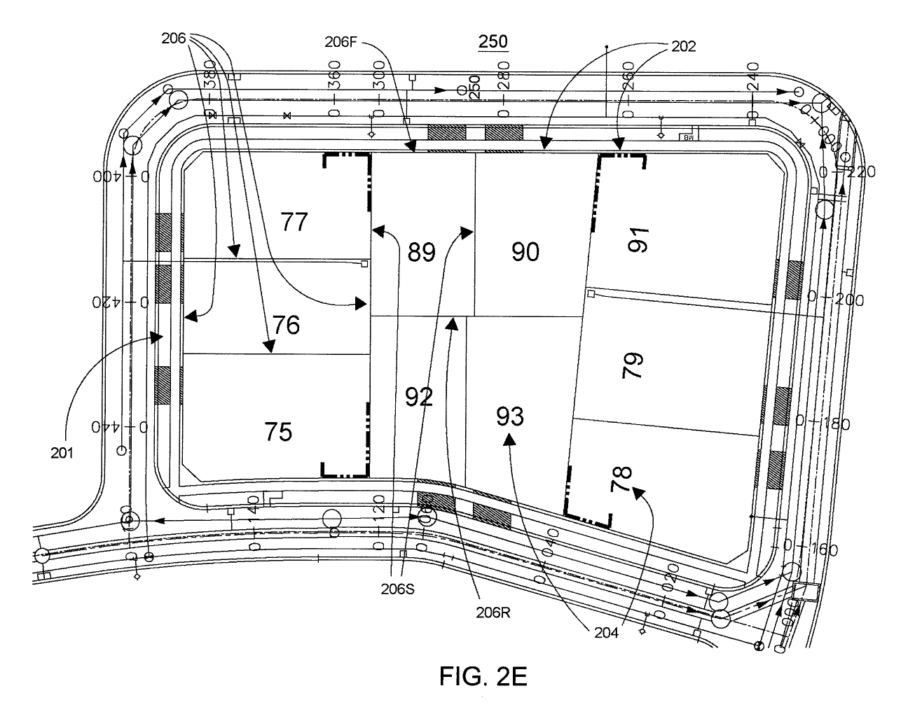

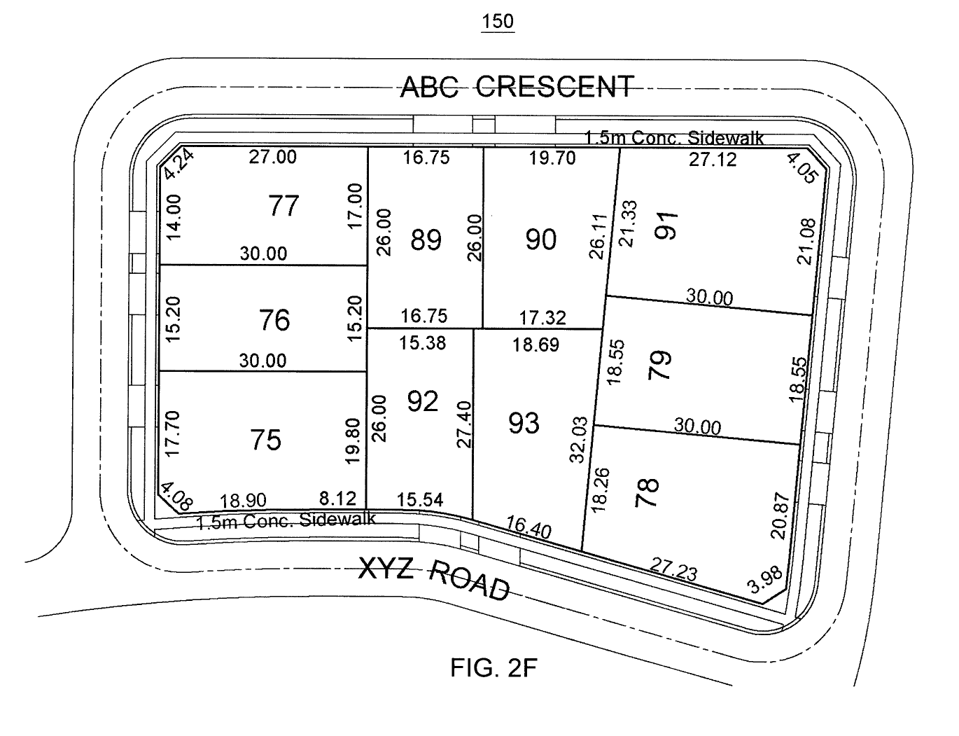

Referring briefly to FIG. 2A, illustrated therein is a top plan view of an example site plan, shown generally as 200, corresponding to a proposed development. As will be understood, the site plan 200 may be in the form of a physical representation (such as a drawing on paper) or it may be electronically stored, for example, in the site database 110. The example site plan 200 may comprise a plurality or set 201 of lots 202, associated with lot identifiers 204 uniquely identifying each lot 202. If the site plan 200 is stored in the site database 110, it may comprise corresponding image data to enable it to be graphically displayed on the display 106. The site plan 200 may or may not also comprise sidewalk 203 and roadway 205 information, as well as other development details, as will be understood. FIG. 2D illustrates an additional example of a site plan 200 with identified lots 202, lot identifier 204 and roadway 205 information.

Referring briefly to FIG. 2B, illustrated therein is a top plan view of an example first layout record, shown generally as 250, corresponding to the site plan 200 of FIG. 2A. The example layout record 250 is an electronic survey drawing which has previously been prepared by a registered land surveyor and stored for example, in the site database 110. As will be understood, the example layout record 250 may include the same plurality or set 201 of lots 202, having lot identifiers 204 corresponding to those in the site plan 200. The example layout record 250 may also comprise corresponding image data to enable it to be graphically displayed on the display 106. The layout record 250 also typically includes lines or line segments 206 which correspond to delimiters or boundaries of each lot 202. Each lot boundary 206 corresponds to at least one lot 202, and may correspond to a plurality of lots 202. As will be understood and discussed in greater detail below, in some instances, a lot boundary 206 will often be a front, side or rear boundary. As well, in some instances for one lot 202, a lot boundary 206 may be a side boundary, while at the same time for an adjoining lot 202 the lot boundary 206 may be a rear boundary. More than one layout record 250 may be stored and used to generate a siting plan 150 as disclosed herein. For example, a second layout record, which may comprise or correspond to a further survey or engineering drawing may also be stored in the site database 110. FIG. 2E illustrate an additional example of a layout record 250 corresponding to the site plan of FIG. 2D as may be prepared by a civil engineer. FIG. 2E illustrates lot boundaries 206 and additional engineering details.

The layout record 250 will typically be formed of various objects, such as the line segments, curves, or arcs and lot identifiers 204, noted above. Other objects, such as driveway lines, sidewalk boundaries, street lines, street curbs, sewage and water pipe layouts, fire hydrants, etc. may also be included in the layout record 250, but not all of which will necessarily be replicated in the siting plan 150.

Referring briefly to FIG. 2C, illustrated therein is a top plan view of an example siting plan, shown generally as 150, as may be generated herein. FIG. 2F illustrates an additional example of a siting plan 150 that may be generated corresponding to the site plan of FIG. 2D.

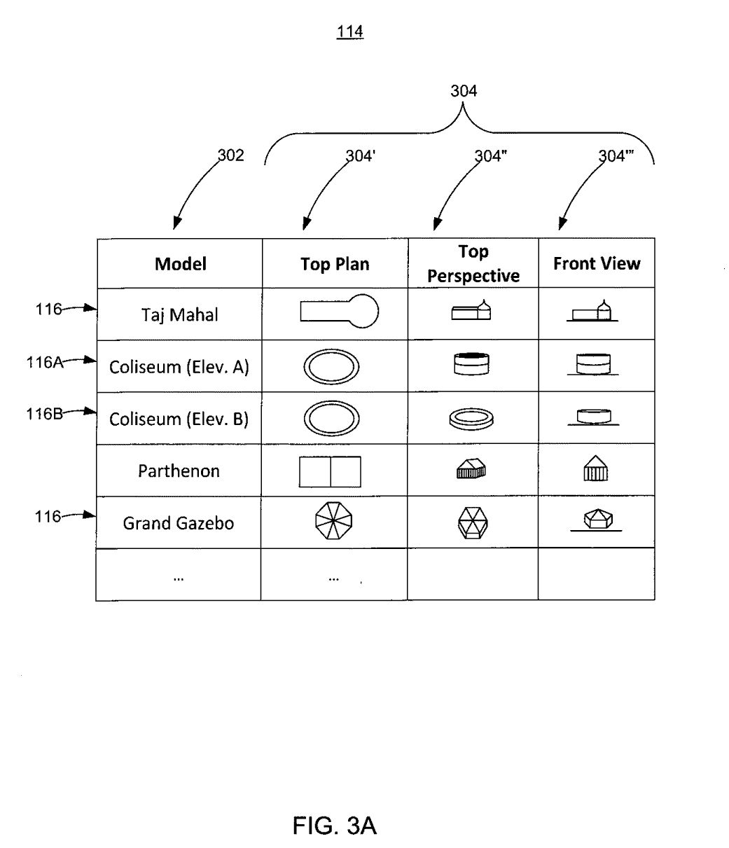

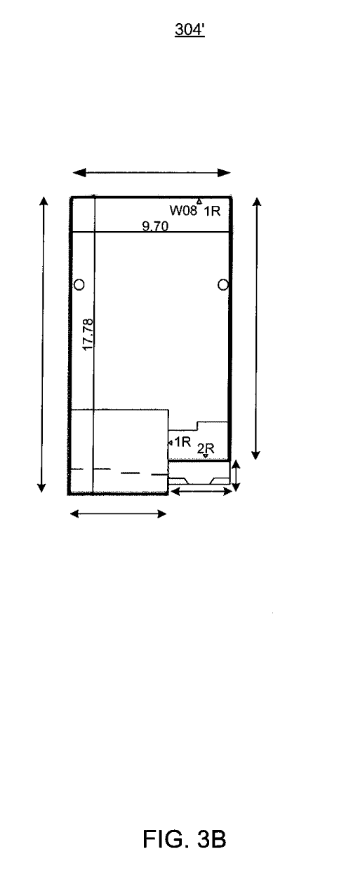

Referring briefly to FIG. 3A, illustrated therein is a schematic illustration of example model records 116 containing exemplary data as may be stored in the model database 114. The data stored in each model record 116 may include a model identifier 302 (such as a model name), together with at least one architectural/siting image 304 for the corresponding model 302. For example, the architectural/siting image 304 may be in the form of a top plan architectural drawing 304′ or model plan which may also describe the footprint of the model 302 and contain basic architectural information for siting the model 302 on a lot 202. In addition, the architectural image 304 may also include a top perspective 304″ and/or a front view 304″ image of the model 302. As illustrated in FIG. 3A, separate model records 116A, 116B may also be provided for each elevation of a particular model.

Referring briefly to FIG. 3B, as noted above, illustrated therein is an example top plan architectural/siting image 304′ as may be stored in a model record 116 and/or template table.

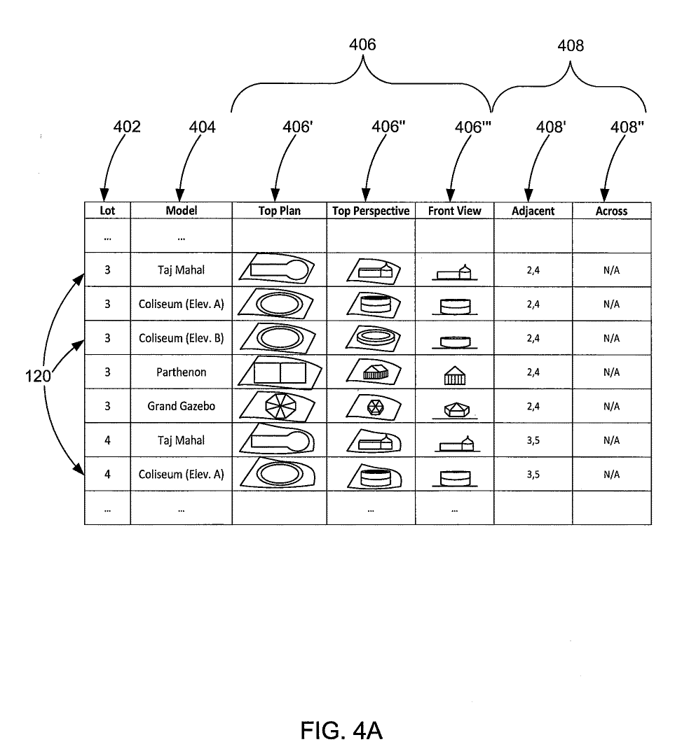

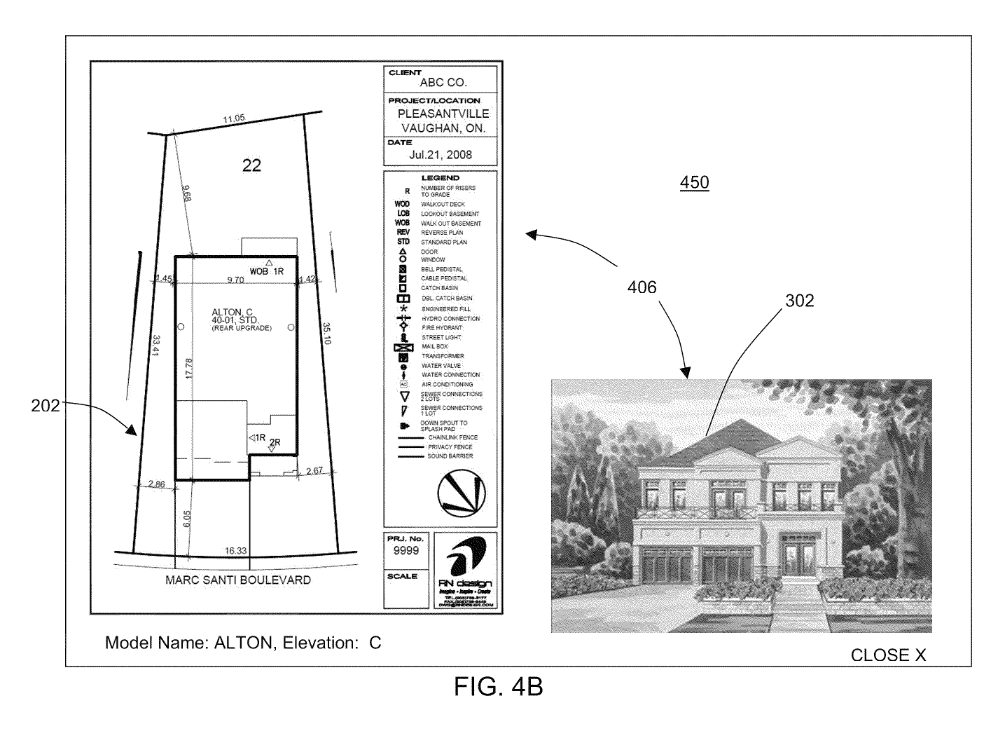

The system 100 may also be provided with a model/lot siting database 118 configured to store at least one and typically a plurality of model/lot siting records 120 as may be generated by the siting generator 109 as described in greater detail, below. Referring briefly to FIG. 4A, depicted therein is a schematic illustration of example model/lot siting records 120 containing exemplary data as may be generated herein and stored in the model/lot siting database 118. Each model/lot siting record 120 corresponds to a lot 202/model 302 combination, and accordingly may be provided with lot 402 and model 404 identifiers, typically corresponding to the lot 202 and model 302 identifiers used in the site plan database 110 and model database 114, respectively. Each model/lot siting record 120 may also be provided with one or more schematic diagrams or images 406 of the model 302 as sited on the corresponding lot 202 (if such model 302 can be sited on the lot 202, as may be determined herein). For example, top perspective images 406″ of the model sited on the lot may be generated and in some instances front 406′″, top plan 406′ and side (not illustrated) and/or rear views (not illustrated) of the models as sited on the lot may also be created and/or stored. In some instances, for example if a model 302 is too large to be sited on a lot 202, a corresponding image 406 may not be generated. (In such instances, alternate embodiments may still generate the corresponding image 406 but with warnings that the model 302 may need to be modified or adjusted for a desired lot 202.) Referring briefly to FIG. 4B, illustrated therein is an example screenshot 450 of exemplary images 406 of a particular model 302 sited on a particular lot 202, as may be presented on the display 106. In some embodiments, the image data 406 may be 3-dimensional.

The system 100 will also typically include an input module 130 which may comprise part of the siting generator 109 and be operatively coupled to the input device(s) 108 and to the various databases 110, 114, 118. The input module 130 may be configured to receive input from a user to control the siting generator 109 in the generation of the siting plan 150, as described herein.

The siting generator 109 is generally configured to site all models on each of the lots. In alternate embodiments, it should be understood that one or more models may be sited on one or more lots. The siting generator 109 may be configured to site the selected model(s) on the selected lot(s). A user may select such model(s) or subsets of models for siting on such lot(s) or subsets of lots via input device 108.

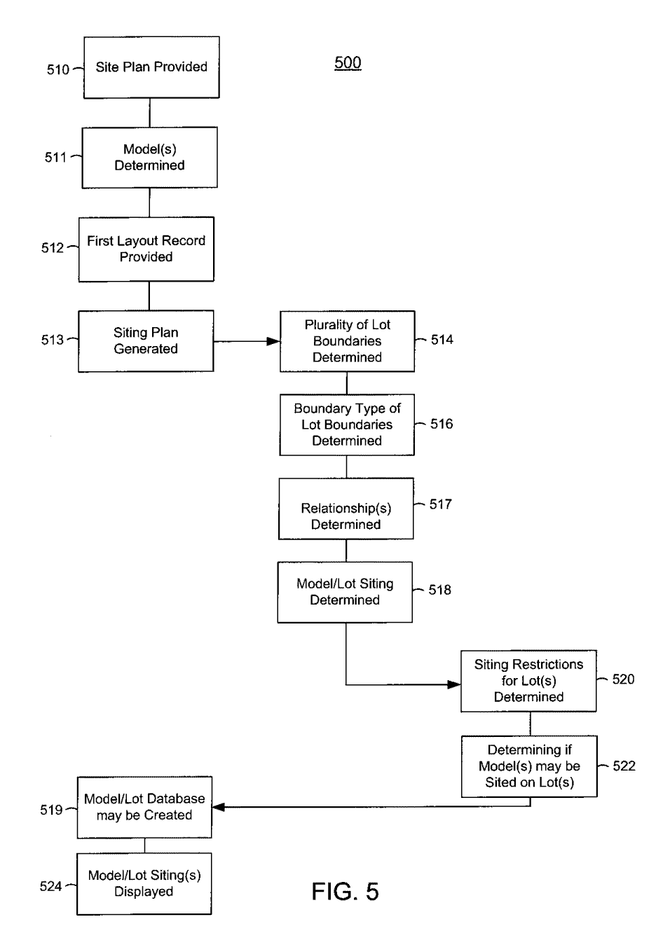

Referring now to FIG. 5, a flowchart illustrating steps of a method of siting at least one model on a siting plan, in accordance with at least one embodiment, is shown generally as 500. Additional details of some of the features described below in respect of the steps of method 500 may be described elsewhere in the present specification.

In one embodiment, the steps of method 500 are performed by an application(s) (e.g. siting generator 109 of FIG. 1) that typically executes and resides on the CPU 102. The application need not be a stand-alone application, and the functionality described herein may be implemented in one or more applications executing and residing on the CPU 102 or remotely.

At Block 510 the site plan(s) 200 may be determined and/or provided. As noted above, the site plan 200 includes a set of at least one lot 202, and may or may not be stored electronically in the memory 104. At least one, and typically a plurality of models 302 may be determined (Block 511). Model data may be generated or otherwise provided and stored, for example, in a corresponding model record 116 for each of the models 302, in the model database 114. Such model data 114 will typically be created by an architectural firm in designing the various models 302 to be available for the development project. As noted previously, each model record 116 may contain a model plan 304′ (which contains dimension data) corresponding to the footprint of the corresponding model 302. A first layout record 250 corresponding to the site plan 200 may also be provided, and typically stored in the site database 110 (Block 512). As previously noted, for example, a layout record 250 may, for example, be in the form of an engineering drawing or a survey drawing, having accurate measurement and/or location data. Other types of drawings, typically in CAD (computer assisted design) and/or other electronic format, may be used. Additional or second layout records 250 may also be provided. For example, a first layout record 250 may be in the form of a survey drawing and a second layout record may be in the form of an engineering drawing (or vice versa). A siting plan 150 corresponding to the layout record(s) 250 may be generated (Block 513). In generating the siting plan 150, as its starting point, the generator 109 may extract and replicate data from the layout record 250. As noted, the first layout record 250 may include a variety of objects which have been created for the survey of the project, such as lot lines, lot dimensions, lot numbers and right of ways. Another typical layout record may include civil engineering drawings. These may include other types of objects however, some of these objects (eg. water and sewage pipe layouts) may not be necessary for developing the model/lot siting information and may be selectively ignored when generating the siting plan 150.

As part of the process of generating the siting plan 150, the siting generator 109 may utilize the layout record data 250 (or alternatively the replicated data as stored in the siting plan 150) to determine a plurality of lot boundaries 206, with each determined lot boundary 206 corresponding to a lot 202 on the siting plan 150 (Block 514). Each lot boundary may be determined from some or all of the line segments 206 in the layout record 250 delimiting the lot(s) 202, and stored in the siting plan 150 record.

As part of this process, the generator 109 module creates a polygon (closed polyline) for one or more lots 202 as may be designated by a user via the input module 130. Alternatively, the generator 109 may create a polygon for all of the lots 202 in the siting plan 150.

Typically, the layout records 250 will have been marked with lot numbers. Such lot numbering data may be selected and duplicated on the corresponding siting plan 150 when created by the generator 109. As noted below, the generator 109 is configured to be able to “recognize” the lot numbering data, and creates a closest boundary around each selected lot number. If no polygon can be created for a specific lot number, or the lot area is too big/small (which is controlled by pre-set parameters), the generator 109 will draw a red circle around that lot number and prompt the user to take action.

Creating a boundary around a given object using a given set of line/arc segments is a computational geometry problem. While two lot lines may visually appear to be connected at one point, it is possible when the original layout record 250 was created, the end points of such lot lines 206 were slightly spaced apart from each other.

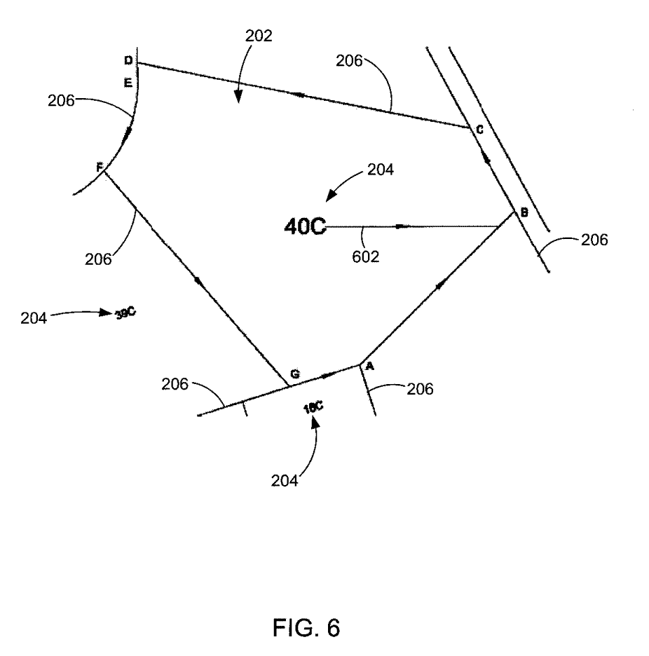

Referring simultaneously to FIG. 6, which illustrates a close-up portion referred to generally as 600 of an example siting plan 150 as may be generated herein, the generator 109 may be programmed to implement the following steps to determine the boundary for each lot 202 in the set.

1) Check all of the end point of all lot lines 206. If the distance between two end points is within a certain predetermined tolerance, connect them by changing one end point's coordinates to match those of the other.

2) Starting from the lot identifier 204 (lot “40C” in the example illustrated in FIG. 6), extend a ray 602 in a first direction (either predetermined or random direction), and identify all the lot line segments 206 which intersect with the ray 602 and select the closest one (line AB in the example). The lot identifier 204 may be stored, for example, in the first layout record 250 as a lot identifier object (which may then be recognized as such by the siting generator 109), or alternatively, the siting generator 109 may be programmed to include OCR (optical character recognition) functionality to enable it to scan the siting plan 150 to detect and recognize the various lot identifiers.

3) “Travel” counter-clock-wise on the first selected lot line 206 (line AB in the example) to locate the closest line which intersects with the first (line BC in the example). In alternate embodiments, the “travel” direction implemented by the generator 109 could be clock-wise, as will be understood. As will be understood, a particular line may extend beyond the boundaries of a particular lot 202 (see eg. line BC in the example illustrated in FIG. 6, which extends beyond the intersection points B, C of the lot “40C”). Lines extending beyond the intersection points are truncated at the intersection points.

4) Continue “traveling” counter-clockwise to find and select the closest lot line 206 (or arc) which intersects with the previously-selected lot line 206 (see eg. lines CD, DE, EF, FG, GA in the example), until the last end point corresponds to the start point (see eg. point A in the example on FIG. 6) or lies on the first segment 206.

5) The polygon defined by the above process is the lot area polygon defining the lot 202, with each line segment determined to be (and saved as, typically in the siting plan 150) the lot lines 206 for the corresponding lot 202. In the example in FIG. 6, polygon ABCDEFG is the lot area polygon defining the lot “40C”, with the line segments AB, BC, CD, DE, EF, FG, GA determined to be the lot lines 206 for the lot 202.

Additionally, in some implementations, a boundary type for each determined lot boundary 206 may be determined (Block 516). By way of example, the boundary type may include front, rear and side. Referring briefly to FIG. 2B, a front lot boundary 206F demarks the frontage of lot “2”, while side boundaries 206S demark the lot line between lots “1” & “2”, and “2” & “3”, respectively. Rear lot boundary 206R demarks the rear lot line of lot “2”, that it shares with lot “7”. This boundary type data may be stored, for example, in the site plan database 110, and may in some instances form part of the siting plan 150 record data. It should be understood that a lot boundary for one lot may comprise a segment of a boundary for a second lot. For example, referring to FIG. 2E, the rear boundary of lot “77” forms only a segment of a side boundary 206S for lot “89”. Similarly, a boundary for one lot may encompass boundaries for multiple neighbouring lots. For example, a side boundary of “89” encompasses the rear boundary of lot “77” and a segment of the rear boundary for lot “76”,

The siting generator 109 may also be configured to determine the relationship between at least two lots 202 (Block 517). For example, the generator 109 may be configured to determine which lots 202 are adjacent to each other, or which lots 202 are across a road, back to back, or kitty corner to each other. Other or additional types of lot relationships may be determined. Referring again to FIG. 4A, such relationship data 408 may be stored in the model/lot siting database 118. For example, which lots 202 are adjacent 408′ to each other or across 408″ a laneway to each other may be determined and stored. Such data may alternatively be stored in the siting plan 150 record data, or a separate lot database (not illustrated) may be created to store information about the relationship of lots as determined by the siting generator 109.

As will be discussed in further detail below, in some embodiments, determining the boundary type for each lot line 206 of Block 516 may be conducted as part of the process of determining the adjacency relationship between lots of Block 517.

The boundary type for a particular lot line 206, whether it be a front, a flankage (or side), or a rear lot line may affect how zoning requirements such as setbacks are determined for a particular lot 202. The generator 109 may analyze each of the lot area polygon determined in Block 514 and distinguish types (Front, Rear, Flankage (Left or Right), etc.) of each lot line 206 forming the lot area polygon for a particular lot 202. The module 109 may also establish the proximity relationship of “neighbor” lots 202—in some implementations, for example, the proximity relationship may specifically include which lot 202 is on the left side of a lot 202, and which lot 202 is on the right side. This proximity relationship analysis is actually polygon relation analysis, which can be classified as a “static” problem in computational geometry.

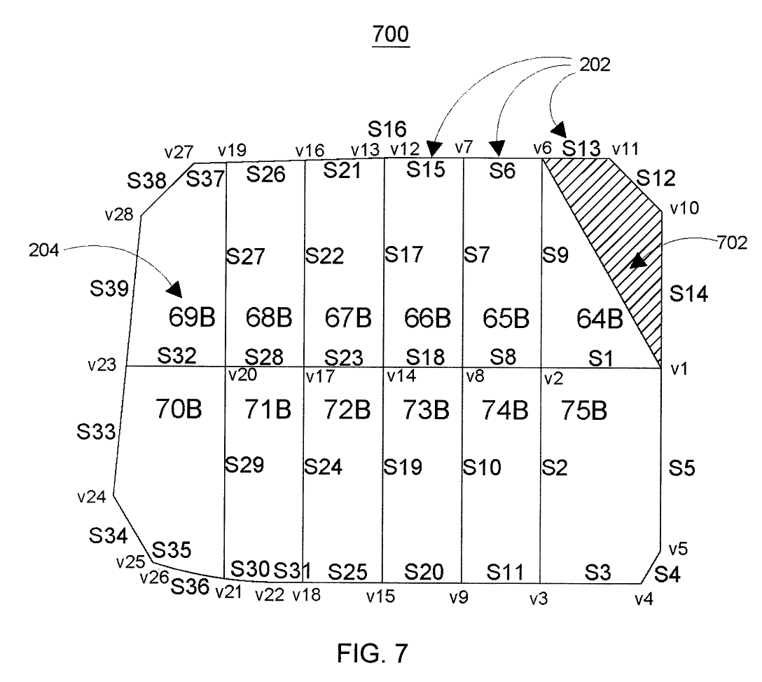

The process of proximity relationship analysis which may be implemented by the generator 109 is discussed below in relation to FIG. 7, which illustrates a close-up portion referred to generally as 700 of an example siting plan 150, as may be generated, stored and analyzed in accordance with the present disclosure:

1) Build 4 lists (as identified in Table 1).

TABLE 1

| List Name | Content |
|---|---|
| Vertex List | VertexId, VertexCoord, |
| | OwnerPolygonId |
| Segment List | SegmentId, VertexId1-VertexId2, |
| | OwnerPolygonId |
| Polygon | PolygonId, Lot Number, Number |
| | of Segments, LeftLot, RightLot |
| Segment-Polygon | SegmentId, PolygonId, Segment |
| | Sequence in Polygon, SegType |

2) For each polygon (lot area) corresponding to a lot 202 created in Block 514:
a) Identify each vertex or intersection point (see eg. vertices V1-V28 in the example in FIG. 7) and ensure that each vertex is included in the vertex list.
b) Identify each segment or lot line 206, and ensure that it is included in the segment list.
c) Add segment id, polygon id into the segment-polygon list.
   3) Determine the FRONT and SIDE segments 206 by creating an outline polygon.
a) In the segment list, find all segments or lot lines 206 which belong to only one polygon (or lot 202), and identify the boundary type for these segments 206 to be FRONT. Chain them into a “large” polygon, counter-clockwise (see eg. segments S14-S12-S13-S6-S15-S16-S21-S26-S37-S38-S39-S33-S34-S35-S36-S30-S31-S25-S20-S11-S3-S4-S5, illustrated in FIG. 7).
b) “Traveling” sequentially through the chain of segments (or lot lines 206) created above, check the “owner” polygon (or lot 202) of each segment. If the owner/lot 202 changes, it means the new polygon is at the right side of the old. Fill the neighborhood/relationship information into the polygon list. (see eg. in the illustration the next segment after S20 is S11, thus, lot “74B” is identified as a lot 202 to the right of lot “73B”.)
c) If a segment belongs to two consecutive (neighbored) polygons or lots 202 in the chain, the segment or boundary 206 is determined to be a SIDE boundary type. It is also possible to determine that the segment 206 in the left polygon is a RIGHT lot line 206, whereas the same segment 206 in the right polygon is a LEFT lot line 206 (See eg. in FIG. 7, the segment S10 belongs to both lots “73B” and “74B”, it is a right side lot line 206 for lot “73B” and left side lot line 206 for lot “74B”).
   4) Determine the REAR segments 206.

After step 3) above, all segments 206 which have not been identified as either FRONT or SIDE are identified as being of a REAR boundary type (see eg. in FIG. 7, segments S8, S18, S23 and S28).

5) Identify the corner lots 206.

A line may be drawn from the start point or vertex of the first FRONT segment to the end point of the last FRONT segment 206, creating a polygon for the front area (as illustrated in hatched area 702 in lot “64B” in FIG. 7, created by joining starting vertex V6 to ending vertex V1). If the area is ⅓ or more of the total lot area, this lot 202 is determined to be a corner lot. Either the first or the last SIDE lot line 206 is retained, whichever is longer, and the remaining SIDE lot line(s) 206 are changed into REAR lot line(s) 206. The FRONT segment 206 close to the new REAR lot line 206 is changed to be a FLANKAGE lot line 206. (If the next FRONT segment length is not very long, it may also be changed to the FLANKAGE boundary type, as well. At least one FRONT lot line 206 is retained (as a FRONT lot line 206).

Steps 1) to 5) discussed above form a simplified explanation of the relation analysis process when the lots form a substantially “island” shape. The module 109 may be programmed with other rules to identify and address more complicated situations, e.g. two back-to-back lots 202 which share only half of a BACK lot line 206, or, instead of an island shape, the group or set of lots 202 form a P-shape, I-shape or dumb-bell-shape.

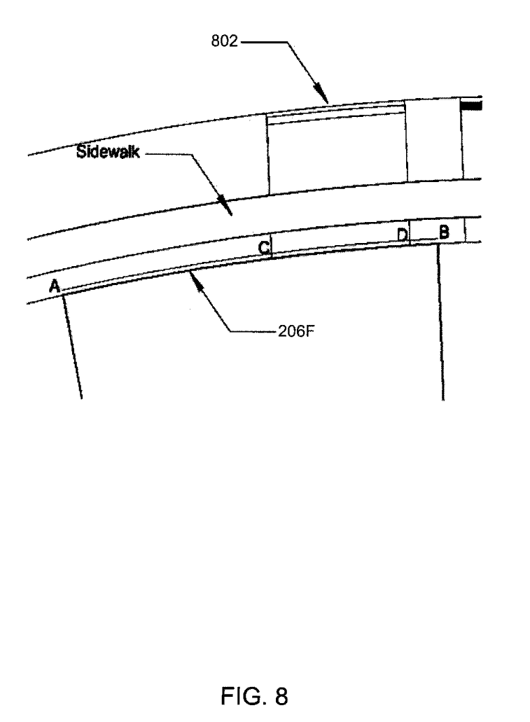

Referring simultaneously now to FIG. 8 (which illustrates another example portion referred to generally as 800 of an alternate example siting plan 150), in some embodiments the module 109 may also be configured to determine the driveway location 802 for one or more lots 202. Utilizing the boundary type determined for the various lot lines 206, the module 109 may duplicate the FRONT lot line 206F of the lot area polygon which may then be offset about 5 cm outside the lot area polygon (as shown by arc AB in FIG. 8). The generator 109 may then detect the intersection points between the new line segment and any driveway lines close by (as illustrated in the example in FIG. 8, there are two intersection points detected: C and D). The generator 109 may then calculate the mid-point of all the intersection points determined. If the mid-point is close to left end of the FRONT lot line 206F, the driveway is determined to be located at the left side of the lot 202, otherwise, the driveway is determined to be located on the right side. (As shown in FIG. 8, the mid-point of CD is close to point B, which is the left end of the FRONT lot line 206F, which indicates that the lot 202 in the example has a left side driveway.) The program 109 may prompt the user to select one or multiple lots 202, run the process described above for each lot 202, and store the result (Left Driveway or Right Driveway), in some embodiments as Xdata attached to the lot area polygon in the siting plan 150. (As will be understood, Xdata may represent “extended object data” that may be attached to a data object such as the lot area polygon.)

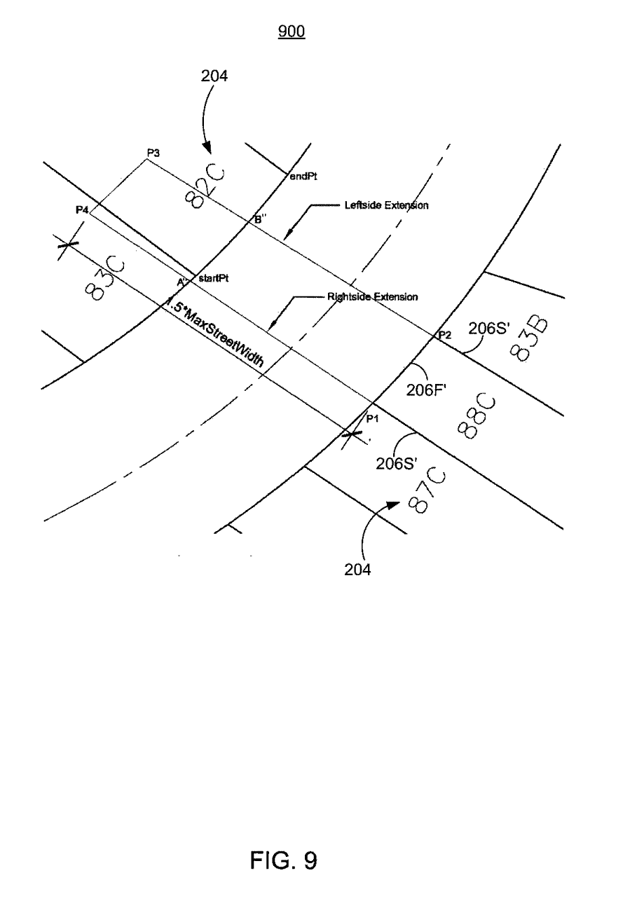

Referring simultaneously now to FIG. 9 (which illustrates an example portion referred to generally as 900 of an additional example siting plan 150), the siting generator 109 may further be configured to determine another proximity relationship between lots 202, namely which lots 202 are across the street from each other. Such information may be useful, for example, with certain zoning restrictions which may prevent the same housing model from being built on lots 202 directly across the street from each other. The module 109 may be configured to enable the user to select one or more lots 202 on which to perform this analysis. For each lot 202 polygon selected, the module 109 may:
1) Determine the FRONT lot line 206F′ and two SIDE lot lines 206S′. The two SIDE lot lines 206S′ may be extended 1.5*MaxStreetWidth (“MaxStreetWidth” representing a predetermined value which corresponds to the maximum width of the streets in the proposed development or subdivision) towards the other side of the street.
2) Use cross selection to select the lot(s) 202 which cross or overlap the polygon created by extending the SIDE lot lines 206S′ as noted above. (See eg. in FIG. 9, applying this process to lot “88C”, lots “82C” and “83C” overlap the polygon P1P2P3P4, and will be identified as potential “across the street” lots 202 from lot “88C” and selected as a result of this process).
3) Calculate the intersection points between the side extensions and the FRONT lot line 206 of the selected lots 202 (see eg. in FIG. 9, intersection points A″ and B″).
4) The module 109 may then determine the intersection point between the left side extension line (see eg. line P2P3 in FIG. 9) and FRONT lot line 206 (see eg. point B″ in FIG. 9). The module 109 may then be configured to calculate the distance from this intersection point to the start point (“startPt” on FIG. 9) of the FRONT lot line 206. If the distance is greater than a predetermined percentage, e.g. 20%, of the whole FRONT lot line 206, these two lots 202 (“88C” and “82C”) may be determined to be across street lots to each other (and have a corresponding proximity relationship).
5) The module 109 may then determine the intersection point between the right side extension line (see eg. line P1P4 in FIG. 9) and FRONT lot line 206 (see eg. point A″ in FIG. 9). The module 109 may then be configured to calculate the distance from this intersection point to the end point (see eg. “endPt” on FIG. 9) of the FRONT lot line 206. If the distance is greater than a predetermined percentage, e.g. 20%, of the whole FRONT lot line 206, these two lots 206 may be determined to be across street lots to each other (and have a corresponding proximity relationship). In the example illustrated in FIG. 9, there is no intersection point between the right side extension line P1P4 and lot “82C”, this criteria cannot be used to check the relation between lots “88C” and “82C”. However, the module 109 can use the criteria to determine the relationship between lots “88C” and “83C” in FIG. 9. Since the distance between intersection point A″ and the end point of the FRONT lot line 206 for lot “83C” (point startPt shown in FIG. 9 is the end point of the FRONT lot line 206 of lot “83C”) is only about 5%, it is less than a predetermined percentage noted above (eg. 20%), so lots “88C” and “83C” may be determined to not be across-street-lots.

As previously noted, proximity relationship data such as across-street-lot information may be stored in Xdata linked to each lot 202 in the model/lot siting database 118 (see eg. FIG. 4A), siting plan 150 and may also be stored in a separate SQL database. By way of example only, Table 2 illustrates the type of data which may be stored as Xdata for a particular lot 202.

TABLE 2

| Description | Data Type | Data Example |
|---|---|---|
| Lot number | String | 63B |
| Zoning | String | RD1 |
| Number of | Integer | 5 |
| segments | | |
| Segment Type | String | FRBBL |
| Left side lot | String | 62B |
| number | | |
| Right side lot | String | 64B |
| number | | |
| Across street lot | String | 10A |
| number | | |
| Driveway | String | L |
| Location | | |
| Upgrade 1 | String | Rear Upgrade |
| Upgrade 2 | String | |
| Lot Grading | String | WOB |
| Street Name | String | MARC SANTI BOULEVARD |

Setbacks

| | | |
|---|---|---|
| Front | Real | 4.55 |
| Rear | Real | 7.55 |
| LSide1 | Real | 0.65 |
| LSide2 | Real | 1.25 |
| RSide1 | Real | 0.65 |
| RSide2 | Real | 1.25 |
| Flankage | Real | 4.55 |
| Garage | Real | 6.05 |
| One Setback | String | N |
| Each Side | | |
| Coverage | String | Y |
| Required | | |
| Coverage | Real | 35% |
| Percentage | | |
| Porch Included | String | Y |

For at least one combination of a model 302 and a lot 202, a model/lot siting corresponding to a siting of the model 302 on the lot 202, may also be determined (Block 518). In some implementations, at least one model/lot siting is determined for each of a plurality of lots 202 on the siting plan 150. Often, a model/lot siting is determined for each combination of each model 302 and each lot 202.

The following some of the various steps which may be implemented by the siting generator 109 in siting a specific model 302 template (such as the example model template or footprint 304′ illustrated in FIG. 3B) on a parallel-side-lot. For each lot area polygon 202, the corresponding Xdata determined previously is accessed, for example, to obtain driveway location, zoning and polygon details. As will be discussed in greater detail below, the module 109 may then check to determine if there are any zoning and/or siting restrictions for the lot 202 (Block 520). This information may then be used to determine the space available for siting a house or other building. Also as discussed below, the module 109 may determine if it is possible to site a model(s) 302 on a particular lot(s) 202 (Block 522). Such determination may, for example, include determining the approximate width of the model(s) 302, and may also involve determining a width value of the lot(s) 202, and comparing the approximate width of the model(s) 302 to the width value of the lot(s) 202.

Some zoning requirements specify that the amount of area taken up by a building on a lot may not exceed a specified percentage of the lot's overall area. The generator 109 may also be configured to determine if the model footprint 304 would exceed the permissible “coverage” percentage under the zoning requirements by calculating the area of the lot 202 and of the footprint 304 and comparing the two values. If the ratio fails to satisfy the zoning requirements, the generator 109 would determine that the model 302 may not be sited on the particular lot 202, and the corresponding model/lot siting would be n/a.

The siting generator 109 may also be configured to orient the lot area polygon, making the sides align as close as possible with a predetermined Y axis, positioning the FRONT lot line(s) close to the bottom, and setting the rotation angle to be zero. Alternate orientations may need to be determined for lots with non-parallel side lot lines (e.g., wedge or pie-shaped lots). For example, a corresponding Y-axis may be made according to the line bisecting the angle of the wedge. By configuring the lot 202 in this fashion, merging the model data (which may be aligned relative to the same Y axis) is facilitated.

The siting generator 109 may further be configured to create a garage setback pline (GSP) and a house setback pline (HSP) according to the zoning setback value/requirements which may be stored in the Xdata.

The generator 109 may also be configured to determine the maximum width of the template 304′. Such width data may be stored in the corresponding model record 116, or the generator 109 may be configured to calculate it from the footprint data 304′. If the maximum width allowed in setback envelope (in some implementations, the setback envelope may be the width of the lot minus the pre-defined setbacks) is less than template 304′ width (Wt), the template cannot be sited on the lot 202. (As discussed above, alternate embodiments may, in such instances, generate warnings that the model 302 may need to be modified or adjusted for a desired lot 202.) Such a result may be recorded, and the generator 109 may skip to next lot 202 to site the model 302.

If the width of the model footprint 304′ is not too large for the lot 202, the generator 109 may align the template 304′ to the centerline of the lot 202, while attempting to make the distance between house and side lot lines equal on both sides. The model/lot siting data, which may include image data corresponding to the model 302 as sited on the lot 202, for the model 302 and lot 202 combination is then generated.

A model/lot database 118 may be created to store the model/lot sitings generated in Block 518 in model/lot records 120 (Block 519).

Once created and stored, some or all of the siting plan 150 and the model/lot siting 120 image and other data generated by the siting generator 109 may be selectively displayed on the display (Block 524). For example, in a sales application, a user may wish to visualize a particular siting of a model 302 on a particular lot 202, and the corresponding model/lot siting 406 image data for such combination may be displayed on the display 106

It will be understood by persons skilled in the art that the features of the user interfaces illustrated with reference to the example screenshots, siting plans and layouts described herein are provided by way of example only. It will be understood by persons skilled in the art that variations are possible in variant implementations and embodiments.

The steps of a method in accordance with any of the embodiments described herein may be provided as executable software instructions stored on computer-readable media, which may include transmission-type media. Such steps may not be required to be performed in any particular order, whether or not such steps are described in claims or otherwise in numbered or lettered paragraphs.

The invention has been described with regard to a number of embodiments. However, it will be understood by persons skilled in the art that other variants and modifications may be made without departing from the scope of the invention as defined in the claims appended hereto.

1. A method for siting at least one model on a siting plan, the method comprising:
(a) providing a site plan comprising at least one lot;
(b) providing a first layout record corresponding to the site plan;
(c) generating a siting plan corresponding to the first layout record;
(d) determining a plurality of lot boundaries on the siting plan, wherein each lot boundary corresponds to at least one lot on the siting plan;
(e) determining at least one model/lot siting, each model/lot siting corresponding to a model and lot combination.

2. The method of claim 1, wherein the plurality of lot boundaries are determined from the first layout record.

3. The method of claim 1, further comprising:
(a) determining a boundary type for each lot boundary.

4. The method of claim 3, wherein the boundary type is selected from the group consisting of:
(a) Front;
(b) Rear; and
(c) Side.

5. The method of claim 1, wherein (e) comprises determining for each of a plurality of models a model/lot siting corresponding to one lot.

6. The method of claim 1, wherein (e) comprises determining for one model a model/lot siting corresponding to a plurality of lots.

7. The method of claim 1 comprising generating a model/lot siting database comprising at least one model/lot siting record, wherein each model/lot siting record comprises a model/lot siting.

8. The method of claim 1, further comprising:
(a) determining at least one siting restriction for the at least one lot on the siting plan.

9. The method of claim 8, wherein the siting restriction is selected from the group consisting of:
(a) zoning; and
(b) setback.

10. The method of claim 1, further comprising:
(a) providing a model record for each model, wherein each model record comprises a model plan corresponding to a footprint of the corresponding model.

11. The method of claim 1, further comprising:
(a) for at least one model, determining if the model is able to be sited on at least one lot.

12. The method as claimed in claim 1, wherein the siting plan comprises a plurality of lots, the method further comprising:
(a) determining a proximity relationship between at least two lots.

13. The method as claimed in claim 12, wherein determining a proximity relationship comprises identifying which lots in the set are adjacent to each other.

14. A computer-readable medium comprising instructions executable on a processor of a computing device for implementing the method of claim 1.

15. A model siting system for siting at least one model on a siting plan, comprising:
(a) a site plan database comprising at least one electronic layout record corresponding to a site plan having a set of at least one lot;
(b) a siting generator operatively coupled to the site plan database and configured to generate a siting plan corresponding to the layout record;
(c) wherein the siting generator is configured to determine a plurality of lot boundaries on the siting plan, wherein each lot boundary corresponds to at least one lot on the siting plan; and
(d) wherein the siting generator is further configured to determine a model/lot siting corresponding to a combination of a model and a lot on the siting plan.

16. The system of claim 15, wherein the siting generator is configured to determine the plurality of lot boundaries from the first layout record.

17. The system of claim 16, wherein the siting generator is further configured to determine a boundary type for each lot boundary.

18. The system of claim 18, wherein the boundary type is selected from the group consisting of:
(a) front;
(b) rear; and
(c) side.

19. The system of claim 15 further comprising a model/lot siting database operatively coupled to the siting generator and configured to store at least one model/lot siting record corresponding to the model/lot siting determined by the siting generator.

20. The system of claim 15, wherein the siting generator is further configured to determine siting restrictions for at least one lot on the siting plan.

21. The system of claim 15 further comprising a model database configured to store at least one model record, wherein each model record corresponds to a model and comprises a model plan corresponding to a footprint of the corresponding model.

22. The system of claim 15, wherein the siting generator is further configured to determine if a selected model is able to be sited on a selected lot.

23. The system of claim 15, wherein the set comprises a plurality of lots and wherein the siting generator is further configured to determine a proximity relationship between at least two lots.

24. The system of claim 15, wherein the set comprises a plurality of lots and wherein the siting generator is further configured to determine which lots in the set are adjacent to each other.
